(19) United States
(12) Patent Application Publication
(10) Pub. No.: US 2014/0011897 A1
(43) Pub. Date: Jan. 9, 2014

(54) REACTION MIXTURE IN THE FORM OF AN EMULSION AND PROCESS FOR PRODUCTION OF POLYURETHANE FOAMS FROM SUCH A REACTION MIXTURE

(71) Applicants: Wolfgang Friederichs, Koln (DE); Stefan Lindner, Koln (DE); Reinhard Strey, Dormagen (DE); Thomas Sottmann, Koln (DE); Elena Khazova, Mannheim (DE); Lorenz Kramer, Koln (DE); Verena Dahl, Bergisch Gladbach (DE)

(72) Inventors: Wolfgang Friederichs, Koln (DE); Stefan Lindner, Koln (DE); Reinhard Strey, Dormagen (DE); Thomas Sottmann, Koln (DE); Elena Khazova, Mannheim (DE); Lorenz Kramer, Koln (DE); Verena Dahl, Bergisch Gladbach (DE)

(73) Assignee: Bayer Intellectual Property GmbH, Monheim (DE)

(21) Appl. No.: 13/883,013

(22) PCT Filed: Nov. 3, 2011
(86) PCT No.: PCT/EP11/69343

§ 371 Date: Sep. 20, 2013

(30) Foreign Application Priority Data
Nov. 5, 2010 (DE) 10 2010 060 390.2

(51) Int. Cl. C08G 18/06; C08G 18/08

(52) U.S. Cl. CPC C08G 18/06; C08G 18/14
USPC 521/112; 521/160

(57) ABSTRACT

The present invention relates to a reaction mixture in emulsion form, suitable for conversion into polyurethanes, comprising a first phase and a second phase in the emulsion and further comprising the following components: A) polyols; B) blowing agent; C) surfactants; and D) isocyanates, wherein the isocyanate-reactive compounds A) are present in the first phase of the emulsion and the blowing agent B) is present in the second phase. The blowing agent B) is present in the near-critical or supercritical state and the isocyanate D) is present in the second phase in a proportion of ≧10% by weight of the total amount of isocyanate D) in the composition. The invention further relates to a method of producing polyurethane foams by providing such a reaction mixture, wherein a polymerization takes place at the freshly formed interface between the polyol phase and the blowing agent phase, to the use of such a reaction mixture for producing polyurethane foams and also to the polyurethane foams obtained.

The present invention relates to a reaction mixture in emulsion form, suitable for conversion into polyurethanes, comprising a first phase and a second phase in the emulsion and further comprising polyols, blowing agents, surfactants and isocyanates. The present invention further relates to a method of producing polyurethane foams by providing such a reaction mixture, to the use of such a reaction mixture for producing polyurethane foams and also to the polyurethane foams obtained.

One goal of current research and development activities in industry is the production of nanocellular foams. Uses for nanocellular foams include, for example, the thermal insulation of buildings, pipes and refrigerators. The Knudsen effect can be taken advantage of here. There is a distinct decrease in thermal conductivity when the inner structures of foams are on the order of the mean free path of gas molecules. To be used in thermal insulation, a foam should preferably be obtainable in large slabs. Conventional plastics foam typically contains 10³ to 10⁶ bubbles per cm³. It would be desirable to raise the bubble density to above 10⁹ cm⁻³.

Polymeric foams are produced using various blowing agents. Polymers, polymeric fluids or polymerizable mixtures are foamed up using the blowing agent. The latter may be gaseous or a volatile component that is vaporized by the heat of the polymerization reaction or by heating.

The system becomes supersaturated and develops a propensity to form gas bubbles. The system in this state is far away from its thermodynamic equilibrium, the attainment of which requires a nucleation step on the part of the gas bubbles. This process involves for homogeneous and heterogeneous nucleation alike an energy barrier which has to be overcome for each individual bubble to form. The resulting foams are macrocellular.

In general, the details of nucleation events in technical applications are little known and difficult to control. Changes may lead to substantial variability of the product with regard to foam homogeneity and properties. Particles are added or air bubbles introduced in an attempt to initiate nucleation, but very high numeric densities in terms of bubbles cannot be achieved in this way. In addition, the heterogeneous particles remain in the end product.

Microemulsions may be one way of evading the dictate of very high pressures. They are the result of using a surfactant to convert water and oil into a macroscopically homogeneous, thermodynamically stable, nanometre-structured dispersion. A very wide variety of structures are achievable via a specific choice of composition, pressure and temperature. Thus, oil-in-water (o/w) microemulsions contain the oil in the faun of nanometre-sized droplets of oil which have a surfactant film as envelope. The oil, generally a condensed hydrocarbon, may also be replaced by short-chain hydrocarbons such as ethane, propane, etc, or by CO₂. Especially the inversely structured water-in-oil or water-in-CO₂ microemulsions are described in the more recent technical literature. In these types of microemulsions, the aqueous component is the internal phase and the supercritical fluid is the external phase. Very recently there have also been reports of microemulsions of non-aqueous, polar components and even of homopolymers and amphiphilic block copolymers.

In the POSME method (principle of supercritical microemulsion expansion), the blowing agent is in the form of very small droplets within the polar phase of a microemulsion. The diameters of such droplets can be in a range from 1 to 100 nanometres.

The POSME method is described in DE 102 60 815 A1. This application for a patent discloses foamed material and a method of making the foamed material. Foamed material comprising foam bubbles in nanosize is supposed to be produced without having to surmounting the energy barrier typical of phase conversions and nucleus-forming processes. An associated goal is to produce, in a controllable manner, a foamed material that has a numeric density of foam bubbles between 10¹² and 10¹⁸ per cm³ and also an average diameter for the foam bubbles of between 10 nm and 10 μm. The foundation is the dispersion of a second fluid in the form of pools in a matrix of a first fluid. A reaction space contains the first fluid as a matrix and a second fluid in pools. A change in pressure and/or temperature is used to convert the second fluid into a near-critical or supercritical state with a density close to that of a liquid. The second fluid is therefore fully or almost fully in the form of pools which have a uniform distribution in the entire first fluid. Depressurization causes the second fluid to revert to a state of gaseous density, while the pools inflate into foam bubbles of nanometre size. No energy barrier has to be surmounted, nor do the blowing agent molecules have to diffuse to the expanding bubbles.

Any polymerizable substance is said to be generally useful as first fluid. However, express mention is only made of acrylamide, which polymerizes to give polyacrylamide, and melamine, which polymerizes to give melamine resin. The second fluid is supposed to be selected from a group of materials which comprises hydrocarbons such as methane or ethane, alkanols, (hydro)chlorofluorocarbons or CO₂. A further material used is an amphiphilic material that is supposed to have at least one block with affinity for the first fluid and at least one block with affinity for the second fluid.

In this patent application, therefore, the reaction components needed to form a polymer are present in the same phase of the emulsion.

A further example of a polymerizable reaction mixture in a supercritical solvent is disclosed in U.S. Pat. No. 5,387,619. This patent relates to a process for inhibiting chemical reactions in a reactive organic material in fluid form by mixing with a supercritical or near-critical fluid, in particular supercritical carbon dioxide. The process comprises the possibility of using a supercritical fluid, preferably carbon dioxide, to suppress a chemical reaction normally taking place between functionally compatible organic molecules. The reaction can then occur at a predetermined but different-from-normal point in time. A system comprising a polyol, carbon dioxide, a catalyst and MDI is thus described inter alia. It was only after pressure reduction to subcritical conditions that the polyaddition reaction ensued, as was observed from a rapid increase in the viscosity of the mixture.

Polyurethane foams can be produced by dissolving supercritical carbon dioxide in the TDI component as described in EP 0 353 061 A2 and thus serve as blowing agent in foam formation. Nothing is reported concerning microcellular or nanocellular foams, however.

A further way to produce polymers is interfacial polymerization. Two reactants to form the polymer come to react at an interface between phases. One familiar example is the production of nylon-6,10 wherein hexamethylenediamine and sebacoyl chloride in respective suitable solvents that are mutually immiscible are made to react via the macroscopic interface.

An example of the production of a foam with chemical components in both phases is disclosed in WO 2004/050752 A1. This application for a patent concerns compositions and methods of making high-internal-phase-emulsion (HIPE) foams and inverse-high-internal-phase-emulsion (I-HIPE) foams by using supercritical fluids. Foams of this type are useful inter alia in absorbent articles. The method comprises combining a water phase and a supercritical fluid phase, wherein the water phase comprises an effective amount of at least one superabsorbent precursor monomer. An oxidation initiator in one of the supercritical phases or the water phase and a reduction initiator in the other of the supercritical phases and the water phase are combined. The supercritical phase and the water phase form an emulsion and the polymerization of the at least one superabsorbent precursor monomer takes place in the water phase. Altogether, therefore, following the combination of oxidation initiator and reduction initiator, a redox polymerization takes place, but not at the phase boundary between the water phase and the supercritical fluid phase.

It becomes clear from the above that there continues to be a need for alternative methods of producing polyurethane foams having smaller sizes of cell and also for reaction mixtures used in these methods.

We have found that this object is achieved according to the present invention by a reaction mixture in emulsion form, suitable for conversion into polyurethanes, comprising a first phase and a second phase in the emulsion and further comprising the following components:

A) isocyanate-reactive compounds selected from the group comprising polyols, polyetherpolyols, polyesterpolyols, polycarbonatepolyols, polyetheresterpolyols, and/or polyacrylatepolyols, wherein further the OH number of this component A) is ≧100 mg KOH/g to ≦800 mg KOH/g, preferably ≧350 mg KOH/g to ≦650 mg KOH/g, and the average OH functionality of this component A) is ≧2;
B) blowing agents selected from the group comprising linear, branched or cyclic C₁-C₅-alkanes, linear, branched or cyclic C₁-C₅-fluoroalkanes and/or CO₂;
C) surfactants selected from the group comprising alkoxylated alkanols, alkoxylated alkylphenols, alkoxylated fatty acids, fatty acid esters, polyalkyleneamines, alkyl sulphates, alkyl polyethers, alkylpolyglucosides, phosphatidylinositols, fluorinated surfactants, surfactants comprising siloxane groups, and/or bis(2-ethyl-1-hexyl)sulphosuccinate; and
D) isocyanates having an NCO functionality of ≧2;
wherein the isocyanate-reactive compounds A) are present in the first phase of the emulsion and the blowing agent B) is present in the second phase.

The composition of the present invention is characterized in that

the blowing agent B) is present in the near-critical or supercritical state and further in that the isocyanate D) is present in the second phase in a proportion of ≧10% by weight of the total amount of isocyanate D) in the composition.

The reaction mixture of the present invention accordingly comprises two at least partly mutually immiscible phases side by side, wherein the first phase comprises polyols and the second phase comprises the blowing agent and the isocyanate. The second phase is preferably present as internal phase, i.e. for instance in droplets within the first phase. The blowing agent is present in the supercritical state; that is, the conditions which prevail are above the critical temperature T_{c} and the critical pressure p_{c}. However, the blowing agent can also be present in the near-critical state. This is to be understood as meaning that there is a temperature T where the critical temperature T_{c} of the blowing agent satisfies the condition (T_{c}−T)/T≦0.4. This condition can also read (T_{c}−T)/T≦0.3 or (T_{c}−T)/T≦0.2.

The blowing agent can be present in a droplet size of ≧1 nm to ≦100 nm for example. The droplet size can also be ≧3 nm to ≦30 nm. It can be determined for example via dynamic light scattering or neutron small-angle scattering and is to be understood as meaning the mean droplet size. Droplet sizes of this type are attained in particular when the reaction mixture of the present invention is in microemulsion form. A small droplet size is advantageous, since on the composition being further processed into polymer foams it engenders a small size of cell in the foam obtained.

It is further provided that the isocyanate is present in the second phase at ≧10% by weight of the total amount of isocyanate in the composition. But the proportion can also be higher, for example ≧80% by weight or ≧90% by weight. The isocyanate can be present in the blowing agent phase in dissolved, suspended, emulsified or any other form.

After the reaction mixture has been formed, subcritical conditions can be established to cause the emulsified blowing agent to transition into the gas phase and thereby form a microcellular or nanocellular foam. At the same time, the isocyanate becomes available for an interfacial polymerization with the polyol, causing the cell walls of the foam to cure. Without wishing to be tied to any one theory, it is believed that the surfactant quantity is no longer sufficient to separate the polyol and the isocyanate from each other. Interfacial polymerization herein is also to be understood as meaning the interfacial polyaddition reaction of polyols and isocyanates.

The polyols which can be used according to the present invention can for example have a number-average molecular weight Mₙ of ≧62 g/mol to ≦8000 g/mol, preferably of ≧90 g/mol to ≦5000 g/mol and more preferably of ≧92 g/mol to ≦1000 g/mol. When a single polyol is added, the OH number thereof is also the OH number of component A). In the case of mixtures, the average OH number is specified. This value can be determined by reference to DIN 53240. The average OH functionality of the recited polyols is ≧2, for example in a range from ≧2 to ≦6, preferably from ≧2.1 to ≦5 and more preferably from ≧2.2 to ≦4.

Examples of polyetherpolyols that can be used according to the present invention are the polytetramethylene glycol polyethers that are obtainable through polymerization of tetrahydrofuran via cationic ring opening.

Useful polyetherpolyols further include addition products of styrene oxide, ethylene oxide, propylene oxide, butylene oxides and/or epichlorohydrin onto di- or polyfunctional starter molecules.

Examples of suitable starter molecules are water, ethylene glycol, diethylene glycol, butyldiglycol, glycerol, diethylene glycol, trimethylolpropane, propylene glycol, pentaerythritol, sorbitol, sucrose, ethylenediamine, toluenediamine, triethanolamine, 1,4-butanediol, 1,6-hexanediol and also low molecular weight hydroxyl-containing esters of polyols of this type with dicarboxylic acids.

Polyesterpolyols that can be used according to the invention include polycondensates of di- and also tri- and tetraols and di- and also tri- and tetracarboxylic acids or of hydroxycarboxylic acids or of lactones. Instead of the free polycarboxylic acids it is also possible to use the corresponding polycarboxylic anhydrides, or corresponding polycarboxylic esters of lower alcohols, to produce the polyesters.

Examples of suitable diols are ethylene glycol, butylene glycol, diethylene glycol, triethylene glycol, polyalkylene glycols such as polyethylene glycol, also 1,2-propanediol, 1,3-propanediol, 1,3-butanediol, 1,4-butanediol, 1,6-hexanediol and isomers, neopentylglycol or neopentylgycol hydroxypivalate. Other polyols that can be used, alongside these, are those such as trimethylolpropane, glycerol, erythritol, pentaerythritol, trimethylolbenzene or trishydroxyethyl isocyanurate.

Examples of polycarboxylic acids that can be used are phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, succinic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, or trimellitic acid. It is also possible to use the corresponding anhydrides as acid source.

To the extent that the average functionality of the polyol to be esterified is ≧2, it is also possible to make additional concomitant use of monocarboxylic acids such as benzoic acid and hexanecarboxylic acid.

Examples of hydroxycarboxylic acids which can be used concomitantly as reactants during the production of a polyesterpolyol having terminal hydroxyl groups are hydroxycaproic acid, hydroxybutyric acid, hydroxydecanoic acid, hydroxystearic acid and the like. Suitable lactones include caprolactone, butyrolactone and homologues.

Polycarbonatepolyols that can be used according to the present invention are hydroxyl-containing polycarbonates, for example polycarbonatediols. These are obtainable through reaction of carbonic acid derivatives, such as diphenyl carbonate, dimethyl carbonate or phosgene, with polyols, preferably diols, or through the reaction of epoxides such as propylene oxide with carbon dioxide.

Examples of diols of this type are ethylene glycol, 1,2-propanediol, 1,3-propanediol, 1,3-butanediol, 1,4-butanediol, 1,6-hexanediol, 1,8-octanediol, neopentylglycol, 1,4-bishydroxy-methylcyclohexane, 2-methyl-1,3-propanediol, 2,2,4-trimethyl-1,3-pentanediol, dipropylene glycol, polypropylene glycols, dibutylene glycol, polybutylene glycols, bisphenol A and lactone-modified diols of the aforementioned type.

Instead or in addition to pure polycarbonatediols, it is also possible to use polyether-polycarbonatediols.

Polyetheresterpolyols that can be used according to the present invention are compounds that contain ether groups, ester groups and OH groups. Suitable compounds for producing the polyetheresterpolyols are organic dicarboxylic acids having up to 12 carbon atoms, preferably aliphatic dicarboxylic acids having ≧4 to ≦6 carbon atoms or aromatic dicarboxylic acids, which are used individually or in a mixture. Examples that may be mentioned are suberic acid, azelaic acid, decanedicarboxylic acid, maleic acid, malonic acid, phthalic acid, pimelic acid and sebacic acid and also particularly glutaric acid, fumaric acid, succinic acid, adipic acid, phthalic acid, terephthalic acid and isoterephthalic acid. Examples of derivatives of said acids that can be used are their anhydrides and also their esters and hemiesters with low molecular weight monohydric alcohols having ≧1 to ≦4 carbon atoms.

Another component used for producing the polyetheresterpolyols are polyetherpolyols obtained through alkoxylation of starter molecules such as polyhydric alcohols. The starter molecules are at least difunctional, but can also optionally contain proportions of starter molecules of higher functionality, especially trifunctional starter molecules.

Examples of starter molecules are diols having primary OH groups and number-average molecular weights Mₙ of preferably ≧18 g/mol to ≦400 g/mol or of ≧62 g/mol to ≦200 g/mol such as 1,2-ethanediol, 1,3-propanediol, 1,4-butanediol, 1,5-pentenediol, 1,5-pentanediol, neopentyl glycol, 1,6-hexanediol, 1,7-heptanediol, 1,8-octanediol, 1,10-decanediol, 2-methyl-1,3-propanediol, 2,2-dimethyl-1,3-propanediol, 3-methyl-1,5-pentanediol, 2-butyl-2-ethyl-1,3-propanediol, 2-butene-1,4-diol and 2-butyne-1,4-diol, ether diols such as diethylene glycol, triethylene glycol, tetraethylene glycol, dibutylene glycol, tributylene glycol, tetrabutylene glycol, dihexylene glycol, trihexylene glycol, tetrahexylene glycol and oligomer mixtures of alkylene glycols, such as diethylene glycol.

Polyols having number-average functionalities of >2 to ≦8, or of ≧3 to ≦4 can also be used concomitantly alongside the diols, examples being 1,1,1-trimethylolpropane, triethanolamine, glycerol, sorbitan and pentaerythritol, and also polyethylene oxide polyols started on triols or tetraols and having average molecular weights of preferably ≧18 g/mol to ≦400 g/mol or of ≧62 g/mol to ≦200 g/mol.

Polyacrylatepolyols are obtainable through free-radical polymerization of hydroxyl-containing olefinically unsaturated monomers or through free-radical copolymerization of hydroxyl-containing olefinically unsaturated monomers with optionally other olefinically unsaturated monomers. Examples thereof are ethyl acrylate, butyl acrylate, 2-ethylhexyl acrylate, isobornyl acrylate, methyl methacrylate, ethyl methacrylate, butyl methacrylate, cyclohexyl methacrylate, isobornyl methacrylate, styrene, acrylic acid, acrylonitrile and/or methacrylonitrile. Suitable hydroxyl-containing olefinically unsaturated monomers are in particular 2-hydroxyethyl acrylate, 2-hydroxyethyl methacrylate, the hydroxypropyl acrylate isomer mixture obtainable through addition of propylene oxide onto acrylic acid and also the hydroxypropyl methacrylate isomer mixture obtainable through addition of propylene oxide onto methacrylic acid. Terminal hydroxyl groups can also be present in protected form. Suitable free-radical initiators are those from the group of the azo compounds, e.g. azoisobutyronitrile (AIBN), or from the group of the peroxides, e.g. di-tert-butyl peroxide.

The blowing agents B) that can be used according to the present invention can be used in the near-critical or supercritical state. Supercritical carbon dioxide can be used for example. The carbon dioxide can have been introduced from the outside, or have been formed through reaction of water with isocyanate groups. Examples of further blowing agents are linear C₁-C₅-alkanes, branched C₄-C₅-alkanes and cyclic C₃-C₅-alkanes. Specific examples of blowing agents are methane, ethane, propane, n-butane, isobutane, n-pentane and/or cyclopentane. Further examples are the partially or perfluorinated derivatives of methane, ethane, propane, n-butane, isobutane, n-pentane and/or cyclopentane.

Examples of alkoxylated alkanols that according to the present invention can be used as surfactant component C) are ethers of linear or branched alkanols having ≧6 to ≦30 carbon atoms with polyalkylene glycols having ≧1 to ≦100 alkylene oxide units. Ethers of linear alkanols having ≧15 to ≦20 carbon atoms with polyalkylene glycols having ≧5 to ≦30 ethylene oxide units may be concerned for example.

It is further possible to use alkoxylated alkylphenols, alkoxylated fatty acids, fatty acid esters, polyalkyleneamines, alkyl sulphates, alkyl polyethers, alkylpolyglucosides, phosphatidylinositols, fluorinated surfactants, surfactants comprising polysiloxane groups, and/or bis(2-ethyl-1-hexyl)sulphosuccinate.

Fluorinated surfactants can be perfluorinated or partially fluorinated. Examples thereof are partially fluorinated ethoxylated alkanols or carboxylic acids such as perfluorooctanoic acid.

A siloxane-terminated polyalkylene oxide polyether can be an example of a surfactant comprising polysiloxane groups. These surfactants may have a linear or branched construction. This type of surfactant to be used according to the present invention is obtainable for example through the hydrosilylation of an unsaturated compound with a polysiloxane bearing Si—H groups. The unsaturated compound may be inter alia the reaction product of allyl alcohol with ethyleneoxide or propylene oxide.

The surfactant is also obtainable for example through the reaction of polyether alcohols with a polysiloxane bearing Si—Cl groups. All of the end groups in the polyether can be siloxane-terminated groups. It is also possible for mixed end groups to be present, i.e. for there to be siloxane end groups and OH end groups or reaction-functionalized OH end groups such as methoxy groups. The siloxane termination can be a monosiloxane group R₃Si—O— or an oligo- or polysiloxane group R₃Si—O—[R₂Si—O]ₙ—[AO] where n is ≧1 to ≦100 for example. In the case of branched surfactants, the siloxane termination may also be constructed as per R₃Si—O—RSi[AO]—O—[R₂Si—O]ₘ—O—SiR₃ with, for example, m=≧0 to ≦10 or as a comb polymer as per R₃Si—O—[RSi[AO]]ₙ—O—[R₂Si—O]ₘ—O—SiR₃ where m+n=≧0 to ≦250. In the instances mentioned, it is preferable for the R moiety to be an alkyl group, especially a methyl group. The group [AO] is a polyalkylene oxide moiety, preferably polyethylene oxide and/or polypropylene oxide. The group [AO] is also attachable to the siloxane via a connecting group such as C₃H₆ for example.

The composition of the present invention further includes, as component D) an isocyanate having an NCO functionality of ≧2. Isocyanates of this type are also referred to as polyisocyanates. The reaction mixture, then, can therefore react to give polyurethane foams or else to give polyisocyanurate foams.

Examples of suitable polyisocyanates of this type are 1,4-butylene diisocyanate, 1,5-pentane diisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) or a higher homologue (polymeric MDI), 1,3- and/or 1,4-bis(2-isocyanatoprop-2-yl)benzene (TMXDI), 1,3-bis-(isocyanatomethyl)benzene (XDI), and also alkyl 2,6-diisocyanatohexanoates (lysine diisocyanates) having C₁ to C₆ alkyl groups.

In addition to the aforementioned polyisocyanates, it is also possible to make concomitant use of proportions of modified diisocyanates of uretdione, isocyanurate, urethane, carbodiimide, uretoneimine, allophanate, biuret, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

The number of NCO groups in the isocyanate and the number of isocyanate-reactive groups of component A) can be in a numerical ratio of ≧70:100 to ≦500:100 relative to each other in the reaction mixture. This index can also be in a range of ≧180:100 to ≦330:100 or else ≧90:100 to ≦140:100.

The proportions in which the components A), B), C) and D) occur in the reaction mixture of the present invention can have the following exemplifications, which always add up to ≦100% by weight:

component A) ≧5% by weight to ≦70% by weight, preferably ≧10% by weight to ≦60% by weight, more preferably ≧20% by weight to ≦50% by weight;
component B) ≧1% by weight to ≦30% by weight, preferably ≧2% by weight to ≦20% by weight, more preferably ≧3% by weight to ≦15% by weight;
component C)≧1% by weight to ≦50% by weight, preferably ≧3% by weight to ≦30% by weight, more preferably ≧5% by weight to ≦25% by weight; and
component D) ≧5% by weight to ≦80% by weight, preferably ≧20% by weight to ≦70% by weight, more preferably ≧30% by weight to ≦60% by weight.

Embodiments of the present invention are described hereinbelow, the embodiments being freely combinable with each or one another unless the contrary is unambiguously apparent from the context.

In one embodiment of the reaction mixture according to the present invention, the isocyanate D) comprises diphenylmethane 4,4′-diisocyanate and also tolylene diisocyanate.

Surprisingly, the combination of an isocyanate from the diphenylmethane diisocyanate series (2,2′- and/or 2,4′- and/or 4,4′-MDI or else a polymeric MDI) with a proportion of an at least CO₂-soluble isocyanate was found to produce a distinctly finer foam.

The preference here is for an isocyanate from the diphenylmethane diisocyanate series to be combined with. TDI (preferably 2,4- and/or 2,6-TDI).

In a further embodiment of the reaction mixture according to the present invention, the isocyanate D) is present in the second phase at a proportion of ≧90% by weight to ≦100% by weight of the total amount of isocyanate D) in the composition. That is, the isocyanate is preferably completely or substantially completely present in the blowing agent phase. The proportion of isocyanate can also be in a range of ≧95% by weight to ≦100% by weight or of ≧98% by weight to ≦100% by weight. The greater the proportion of isocyanate dissolved in the blowing agent phase and correspondingly the smaller the proportion of isocyanate dissolved in the polyol phase, the greater the effectiveness at which the polymerization can proceed at the phase interface.

Advantageously, in the reaction mixture of the present invention, the isocyanate D) is dissolved in the blowing agent B). Mixtures of different isocyanates are encompassed here as well.

In a further embodiment of the reaction mixture according to the present invention, the reaction mixture is at a pressure of ≧30 bar to ≦300 bar and a temperature of ≧0° C. to ≦100° C. The pressure can also be in a range of ≧40 bar to ≦150 bar or of ≧60 bar to ≦100 bar. The temperature can also be in a range of ≧10° C. to ≦80° C. or of ≧20° C. to ≦60° C.

In a further embodiment of the reaction mixture according to the present invention, the isocyanate-reactive component A) comprises a difunctional polyesterpolyol having an OH number of ≧240 mg KOH/g to ≦340 mg KOH/g.

In a further embodiment of the method according to the present invention, the surfactant component B) is a polyethylene oxide polyether with oligodimethylsiloxane end groups, wherein the number of dimethylsiloxane units is ≦5. A polyether of this type can be represented, for example, by the idealized formula R′O—[CH₂CH₂O]ₒ—X—SiR(O—SiR₃)((O—SiR₂)ₚR) where R═CH₃ and R′═H, CH₃ or COCH₃. Here X can be an optional connecting group such as alkyl-α or ω-diyl, o is ≧1 to ≦100, preferably ≧5 to ≦30 and more preferably ≧10 to ≦20 and p is ≦2. The group X may be —CH₂—CH₂—CH₂— for example. 3-(Polyoxyethylene)propyl-heptamethyltrisiloxane is a preferred surfactant. It is commercially available from Dow Corning under the trade name Q2-5211®.

In a further embodiment of the reaction mixture according to the present invention, the components are present in the following proportions and wherein the weight proportions of the individual components each sum to ≦100% by weight:
a mixture of a difunctional polyesterpolyol having an OH number of ≧290 mg KOH/g to ≦320 mg KOH/g with glycerol in the mixture in a proportion of ≧20% by weight to ≦45% by weight;
CO₂ in a proportion of ≧4% by weight to ≦20% by weight;
a siloxane-polyalkylene oxide copolymer in a proportion of ≧5% by weight to ≦25% by weight; and
a mixture of diphenylmethane 4,4′-diisocyanate plus isomers and higher-functional homologues with 2,4- and 2,6-tolylene diisocyanates in a proportion of ≧20% by weight to ≦40% by weight.

The present invention further provides a method of producing polyurethane foams, comprising the steps of
providing isocyanate-reactive compounds A), blowing agents B), surfactants C) and isocyanates D), wherein the components have a meaning according the above definitions and wherein the blowing agent is present in the near-critical or supercritical state; and
reducing the pressure of the composition obtained, so the blowing agent transitions into the gaseous state.

The isocyanate is at least partly present in the blowing agent phase. It is preferably present therein in a dissolved state. The isocyanate in the blowing agent phase does not react with the polyol as long as conditions are near-critical or supercritical. As the blowing agent expands, the isocyanate and the polyol come into direct contact and an interfacial polymerization can take place.

This method preferably comprises the steps of:
providing a composition comprising isocyanate-reactive compounds A), blowing agent B) and surfactants C) in accordance with the present invention, wherein the blowing agent is present in the near-critical or supercritical state;
adding the isocyanates D) according to the present invention, whereby the isocyanate D) transfers into the blowing agent B); and
reducing the pressure of the resulting composition mixture, so the blowing agent transitions into the gaseous state.

This version initially produces an emulsion or microemulsion comprising the polyol phase and the blowing agent phase. The subsequent added isocyanate is at least partly present in the blowing agent phase. It is preferably present therein in a dissolved state. The isocyanate in the blowing agent phase does not react with the polyol as long as conditions are near-critical or supercritical. As the blowing agent expands, the isocyanate and the polyol come into direct contact and an interfacial polymerization can take place.

In one embodiment of this method, the composition comprising blowing agent is maintained at a pressure of ≧1 bar to ≦300 bar and at a temperature of ≧0° C. to ≦100° C. The pressure can also be in a range of ≧10 bar to ≦180 bar or of ≧20 bar to ≦150 bar. The temperature can also be in a range of ≧10° C. to ≦80° C. or of ≧20° C. to ≦60° C.

In a further embodiment of this method, the converting of blowing agent component B) into the subcritical state takes place in a closed mould, wherein the closed mould is not part of a mixing head of a mixing rig and is set up such that its internal volume and/or the pressure prevailing in its interior can be changed by external agency after the mixture has been introduced.

The present invention further provides a method of producing polyurethane foams, comprising the steps of:
providing a composition comprising isocyanate-reactive compounds A) and surfactants C) according to the present invention;
providing a composition comprising blowing agent B) and isocyanate D) according to the present invention, wherein the blowing agent is present in the near-critical or supercritical state and wherein the isocyanate D) is present in blowing agent B);
mixing the two compositions;
reducing the pressure of the resulting composition mixture, so the blowing agent transitions into the gaseous state.

In this version, the isocyanate is already present in the near-critical or supercritical blowing agent before it is combined with the polyol phase. The isocyanate is preferably present in the blowing agent in a dissolved state. It is further preferable when the composition obtained on mixing the polyol phase and the blowing agent phase is further maintained under conditions under which the blowing agent is near-critical or supercritical.

In one embodiment of this method, the composition comprising blowing agent is maintained at a pressure of ≧1 bar to ≦300 bar and at a temperature of ≧0° C. to ≦100° C. The pressure can also be in a range of ≧10 bar to ≦180 bar or of ≧20 bar to ≦150 bar. The temperature can also be in a range of ≧10° C. to ≦80° C. or of ≧20° C. to ≦60° C.

The present invention further relates to a polyurethane foam obtained by an above-described method.

The polyurethane foam of the present invention may be for example a foam having an average pore diameter of ≧10 nm to ≦10 000 nm. Irrespective of that, the pore density of the polyurethane foam of the present invention can also be from ≧10⁷ pores/cm³ to ≦10¹⁸ pores/cm³.

The present invention likewise provides for the use of a reaction mixture according to the present invention for producing polyurethane foams.

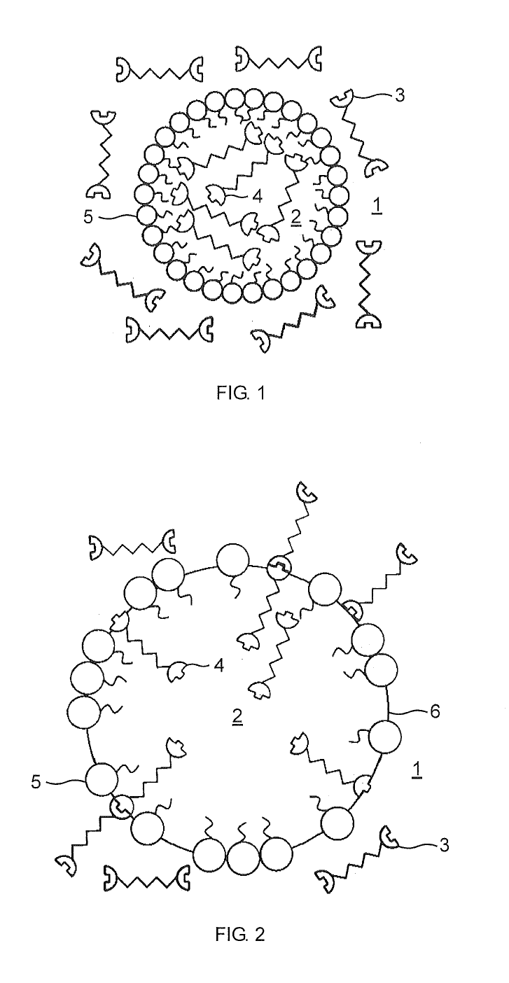

The principle of the method according to the present invention is elucidated schematically with reference to FIGS. 1 to 3 hereinbelow, which show in the case of

FIG. 1 an emulsion of a near-critical or supercritical blowing agent with a reactant in an external phase with another reactant,

FIG. 2 the state of the FIG. 1 emulsion after pressure reduction,

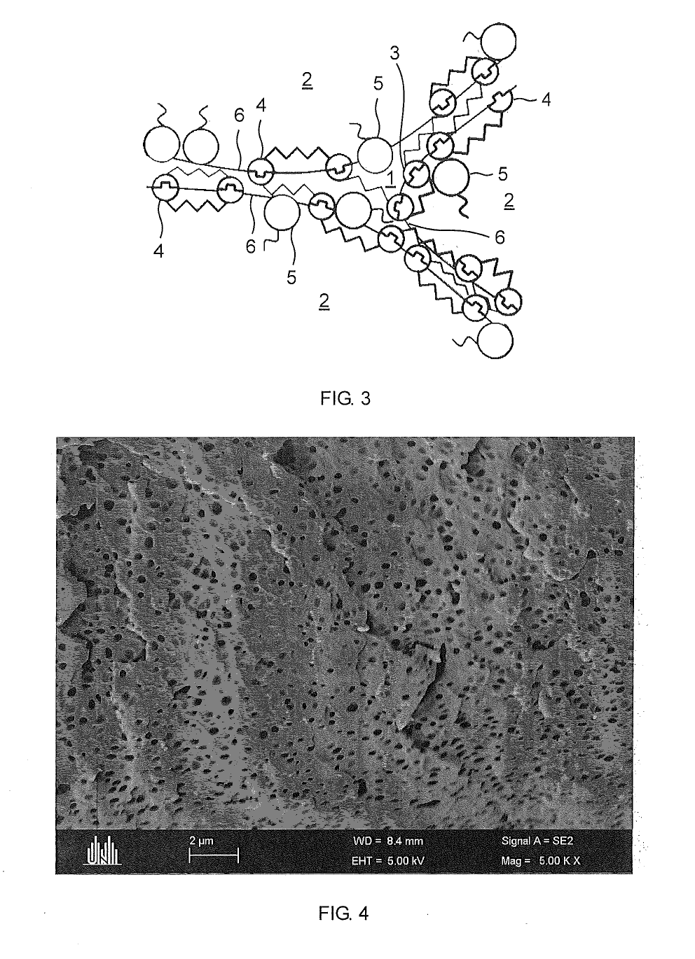

FIG. 3 a magnified view of the phase boundary during the reaction of the reactants

FIGS. 4 to 8 micrographs of polyurethane foams

FIG. 1 shows an emulsion of a near-critical or supercritical blowing agent with dissolved reactant in an external phase with dissolved other reactant. The emulsion, which can also be a microemulsion, comprises an external phase 1 and an internal, droplet-shaped phase 2. The reactant in the polar, external phase 1 is the schematically depicted polyol 3. This external phase 1 can be solvent-free or include water, polar solvents, volatile solvents and mixtures thereof as additional solvents. In addition to the polyol 3, the external phase 1 may additionally contain polymers and also additives such as H₂O, flame retardants such as TCPP or salts, etc.

The apolar, internal phase 2 contains the near-critical or supercritical blowing agent such as, for example, CO₂, methane, ethane, propane or mixtures thereof. The internal phase 2 further contains the schematically depicted isocyanate 4 having a functionality of 2 NCO groups. The isocyanate 4 is present in the internal phase 2, and hence in the blowing agent, in dissolved, suspended, emulsified or any other form. The separation between the internal phase 2 and the external phase 1 is brought about by surfactant molecules 5 which point with their hydrophilic head in the direction of external phase 1 and with their lipophilic tail in the direction of internal phase 2.

FIG. 2 shows the state of the FIG. 1 emulsion after pressure reduction, i.e. after the near-critical or supercritical fluid in internal phase 2 has transitioned into the gaseous state. The droplet of fluid expands in the process. As a result, the amount of surfactant molecules 5 is no longer sufficient to achieve separation between the internal phase 2 and external phase 1. Therefore, the two phases come into direct contact. This is depicted as the phase boundary 6. Since the fluid in internal phase 2 is now in the gaseous state, its ability to dissolve, suspend, emulsify or otherwise accommodate the isocyanate 4 decreases. In the case of a solution, therefore, the isocyanate 4 would precipitate. The precipitated isocyanate 4 at the phase boundary 6 is not separated by surfactant molecules 5 from the polar phase, but comes into direct contact with polyol 3. As a consequence, these reactants react with each other.

FIG. 3 shows a magnified view of the phase boundary during the reaction of the reactants. As the gas bubbles of internal phase 2 continue to expand, they meet, so isocyanate molecules 4 at the edge of one gas bubble in the internal phase 2 can react with a polyol molecule 3 in the external phase 1 and can further react, via a free functionality of polyol molecule 3, with an isocyanate molecule 4 of another gas bubble. In this way, the cell wall of the foam obtained is stabilized, so a foam can be obtained.

The examples which follow illustrate the invention.

### GLOSSARY

Desmodur® 44V20L: mixture of diphenylmethane 4,4′-diisocyanate (MDI) with isomers and higher-functionality homologues having an NCO content of 31.4 wt %, Bayer MaterialScience AG

Desmodur® 44V70L: mixture of diphenylmethane 4,4′-diisocyanate (MDI) with isomers and higher-functionality homologues having an NCO content of 30.9 wt %, Bayer MaterialScience AG

Desmodur® VP.PU 1806: mixture of diphenylmethane 4,4′-diisocyanate (MDI) and diphenylmethane 2,4′-diisocyanate, Bayer MaterialScience AG

Desmodur® T 80: 2,4- and 2,6-tolylene diisocyanate (TDI) in a ratio of 80:20, Bayer MaterialScience AG

Desmophen® VP.PU 1431: difunctional polyesterpolyol, Bayer MaterialScience AG, OH number 310 mg KOH/g

DABCO: 1,4-diazabicyclo[2.2.2]octane

DBTL: dibutyltin dilaurate

Silwet® L-7607: siloxane-polyalkylene oxide copolymer from Momentive

The solubility of various isocyanates in blowing agents was tested in order to determine suitable isocyanates.

The solubility of monomeric MDI (Desmodur® VP.PU 1806), Desmodur® 44V70L and of TDI

(Desmodur® T 80) in propane was determined by premixing equal volumes of isocyanate and propane at a temperature of 25° C. and a pressure of 220 bar. It transpired that VP.PU 1806 and Desmodur 44V70L formed two phases with about 20% of the propane dissolving in the bottom phase (isocyanate) in each case. By contrast, Desmodur® T 80 was completely miscible with propane, i.e. one phase was formed.

The solubility of monomeric MDI (Desmodur® VP.PU 1806), Desmodur® 44V70L and of TDI (Desmodur® T 80) in CO₂ was determined by premixing equal volumes of isocyanate and CO₂ at a temperature of 25° C. and a pressure of 220 bar. It transpired that VP.PU 1806 formed two phases with about 50% of the propane dissolving in the bottom phase (isocyanate) and that Desmodur 44V70L formed two phases with about 50% of the propane dissolving in the bottom phase (isocyanate). By contrast, Desmodur T 80 was completely miscible with CO₂, i.e. one phase was formed.

Determination of Critical Points in a Mixture with CO₂:

Desmodur T 80 and hexamethylene diisocyanate were tested for the critical parameters in a mixture with CO₂ to ensure that the blowing agent mixture is super- or near-critical. It transpired that for HDI the critical point at a temperature of 323 K is at a mole fraction of x_{c}=0.94 and a pressure of p_{c}=165 bar. For Desmodur T 80 the critical point at a temperature of 323 K is at a mole fraction of x_{c}=0.90 and a pressure of p_{c}=159 bar.

A microemulsion obtainable in accordance with the above teaching was converted into a polyurethane foam. For this, the mixture of polyols and catalysts (DBTDL and DABCO) and surfactant was admixed with CO₂ at 34° C. and a pressure of 170 bar. Without wishing to be tied to any one theory, it is believed that a microemulsion of scCO₂ droplets in the polyol phase formed in the process. This emulsion was admixed with the polyisocyanate in a high-pressure mixing head. The reaction mixture was then introduced into a mould with a certain counterpressure. Supercritical conditions therefore continued to prevail in the mould with regard to the CO₂ in the inventive examples. The pressure was reduced to atmospheric only after the materials had been introduced into the mould, the temperature of which was controlled to 35° C., and after allowing for a certain residence time. The residence time was optimized for each foam. The weights reported in the examples are in parts by weight. The entire shot weight was 120 g in each case.

| | Inventive | Inventive | Inventive | Inventive | Comparative |
|---|---|---|---|---|---|
| Components | example 1 | example 2 | example 3 | example 4 | example 5 |
| Desmophen ® VP.PU 1431 | 95.00 | 95.00 | 95.00 | 95.00 | 95.00 |
| glycerol | 15.00 | 15.00 | 15.00 | 15.00 | 15.00 |
| Silwet L-7607 | 45.00 | 45.00 | 45.00 | 45.00 | 45.00 |
| Dabco | 0.28 | 0.28 | 0.28 | 0.28 | 0.28 |
| DBTDL | 0.07 | 0.07 | 0.07 | 0.07 | 0.07 |
| CO₂ | 25.40 | 25.5 | 17.00 | 15.70 | 17.30 |
| Desmodur ® 44V20L | 104.19 | 104.19 | 104.19 | 48.07 | 122.0 |
| Desmodur ® T80 | 11.58 | 11.58 | 11.58 | 48.07 | 0 |
| Index | 90 | 90 | 90 | 90 | 90 |
| isocyanate temperature [° C.] | 34 | 34 | 35 | 34 | 34 |
| polyol temperature [° C.] | 35 | 34 | 34 | 35 | 34 |
| mixing time [sec] | 2 | 2 | 2 | 2 | 2 |
| counterpressure [bar] | 100 | 100 | 100 | 100 | 30 |
| residence time | 20 min | 34 sec | 32 sec | 32 sec | 32 sec |
| demoulding time [min] | 30 | 30 | 30 | 30 | 30 |

FIG. 4 shows an electron micrograph of the polyurethane foam obtained in inventive example 1. It shows that the average pore size is distinctly smaller than 500 nm.

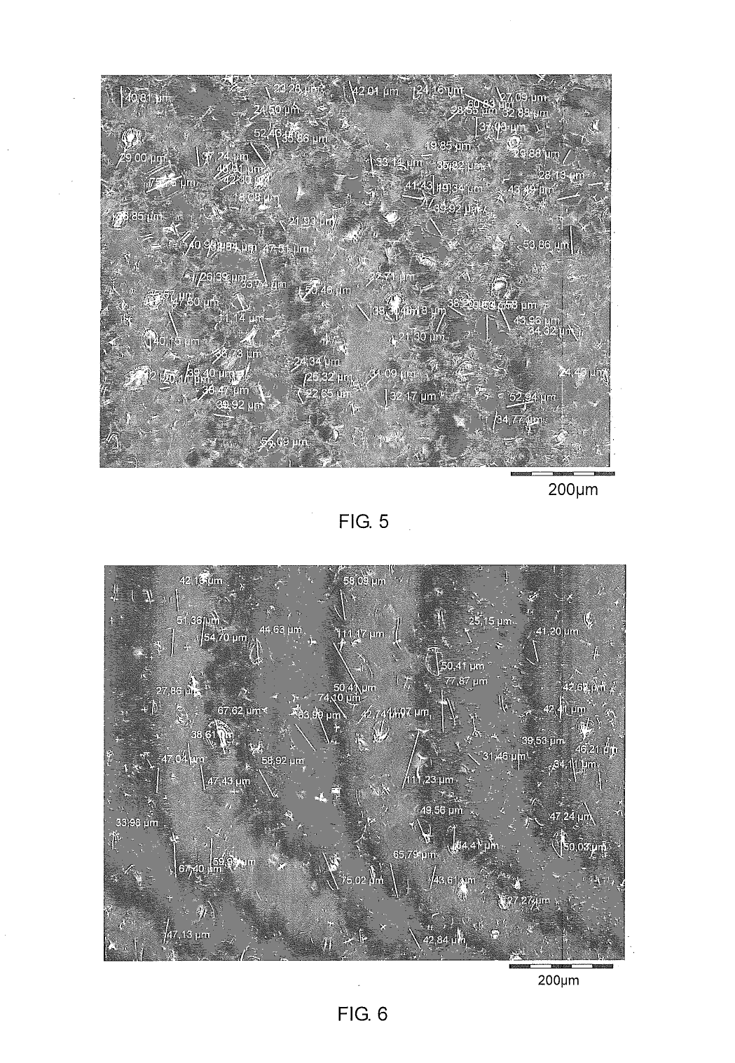

FIG. 5 shows a light micrograph of the polyurethane foam obtained in inventive example 2. This shows a pore size of distinctly below 50 μm.

FIG. 6 shows a light micrograph of the polyurethane foam obtained in inventive example 3. This shows a pore size of distinctly below 80 μm.

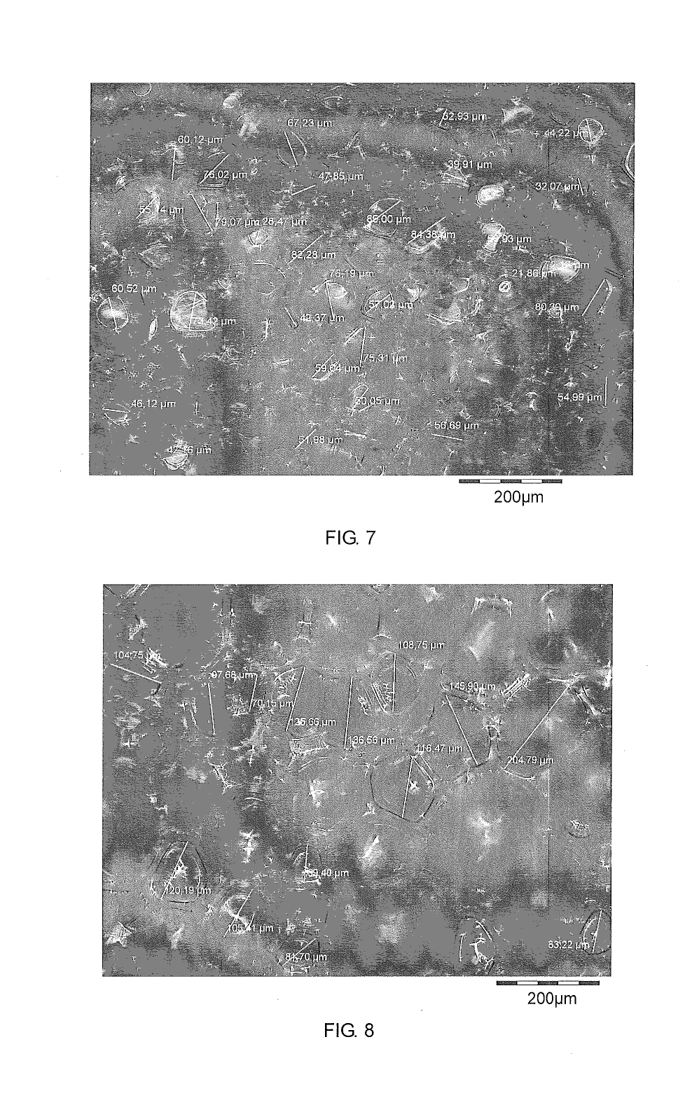

FIG. 7 shows a light micrograph of the polyurethane foam obtained in inventive example 4. This shows a pore size of distinctly below 60 μm.

FIG. 8 shows a light micrograph of the polyurethane foam obtained in comparative example 5. This shows a pore size of distinctly greater than 100 μm.

1-15. (canceled)

16. A reaction mixture in emulsion form, suitable for conversion into polyurethanes, comprising a first phase and a second phase in the emulsion and further comprising the following components:
A) an isocyanate-reactive compound selected from the group consisting of polyols, polyetherpolyols, polyesterpolyols, polycarbonatepolyols, polyetheresterpolyols and polyacrylatepolyols, wherein further the OH number of this component A) is ≧100 mg KOH/g to ≦800 mg KOH/g and the average OH functionality of this component A) is ≧2;
B) a blowing agent selected from the group consisting of linear, branched or cyclic C₁-C₅-alkanes, linear, branched or cyclic C₁-C₅-fluoroalkanes and CO₂;
C) a surfactant selected from the group consisting of alkoxylated alkanols, alkoxylated alkylphenols, alkoxylated fatty acids, fatty acid esters, polyalkyleneamines, alkyl sulphates, alkyl polyethers, alkylpolyglucosides, phosphatidylinositols, fluorinated surfactants, surfactants comprising siloxane groups, and bis(2-ethyl-1-hexyl)sulphosuccinate; and
D) an isocyanate having an NCO functionality of ≧2;
wherein the isocyanate-reactive compound A) is present in the first phase of the emulsion and the blowing agent B) is present in the second phase,
wherein
the blowing agent B) is present in the near-critical or supercritical state and wherein the isocyanate D) is present in the second phase in a proportion of ≧10% by weight of the total amount of isocyanate D) in the composition.

17. The reaction mixture according to claim 16, wherein the isocyanate D) comprises diphenylmethane 4,4′-diisocyanate and tolylene diisocyanate.

18. The reaction mixture according to claim 16, wherein the isocyanate D) is dissolved in the blowing agent B).

19. The reaction mixture according to claim 16, wherein the reaction mixture is at a pressure of ≧30 bar to ≦300 bar and a temperature of ≧0° C. to ≦100° C.

20. The reaction mixture according to claim 16, wherein the isocyanate-reactive component A) comprises a difunctional polyesterpolyol having an OH number of ≧240 mg KOH/g to ≦340 mg KOH/g.

21. The reaction mixture according to claim 16, wherein the surfactant component B) is a polyethylene oxide polyether with oligodimethylsiloxane end groups, wherein the number of dimethylsiloxane units is ≦5.

22. The reaction mixture according to claim 16, wherein the components are present in the following proportions and wherein the weight proportions of the individual components each sum to ≦100% by weight:
a mixture of a difunctional polyesterpolyol having an OH number of ≧290 mg KOH/g to ≦320 mg KOH/g with glycerol in the mixture in a proportion of ≧20% by weight to ≦45% by weight;
CO₂ in a proportion of ≧4% by weight to ≦20% by weight;
a siloxane-polyalkylene oxide copolymer in a proportion of ≧5% by weight to ≦25% by weight; and
a mixture of diphenylmethane 4,4′-diisocyanate plus isomers and higher-functional homologues with 2,4- and 2,6-tolylene diisocyanates in a proportion of ≧20% by weight to ≦40% by weight.

23. A method of producing a polyurethane foam, comprising the steps of:
providing an isocyanate-reactive compound A), a blowing agent B), a surfactant C) and an isocyanate D), wherein the components A), B), C) and D) have a meaning according to claim 1 and wherein the blowing agent is present in the near-critical or supercritical state to form a composition; and
reducing the pressure of the composition obtained, so the blowing agent transitions into the gaseous state.

24. The method according to claim 23, wherein the composition comprising blowing agent is maintained at a pressure of ≧1 bar to ≦300 bar and at a temperature of ≧0° C. to ≦100° C.

25. The method according to claim 23, wherein converting of blowing agent component B) into the gaseous state takes place in a closed mould, wherein the closed mould is not part of a mixing head of a mixing rig, and wherein the internal volume and/or the pressure prevailing in the interior of the closed mould can be changed by external agency after the mixture has been introduced.

26. A method of producing a polyurethane foam, comprising the steps of:
providing a first composition comprising an isocyanate-reactive compound A) and a surfactant C) according to claim 16;
providing a second composition comprising a blowing agent B) and an isocyanate D) according to claim 1, wherein the blowing agent is present in the near-critical or supercritical state and wherein the isocyanate D) is present in blowing agent B);
mixing the first and the second composition to form a composition mixture;
reducing the pressure of the composition mixture, so the blowing agent transitions into the gaseous state.

27. A polyurethane foam obtained by the method according to claim 23.

28. The polyurethane foam according to claim 27, wherein the foam has an average pore diameter of ≧10 nm to ≦10 000 nm.

29. The polyurethane foam according to claim 27, wherein the foam has a pore density of ≧107 pores/cm³ to ≦1018 pores/cm³.

30. A method for producing a polyurethane foam comprising utilizing the reaction mixture according to claim 16.
